(19) United States
(12) Patent Application Publication
(10) Pub. No.: US 2003/0223912 A1
(43) Pub. Date: Dec. 4, 2003

(54) Device, system, and method for aspirating liquids from SPE plates

(76) Inventors: Urs Knecht, Hombrechtikon (CH); Nikolaus Ingenhoven, (US)

Correspondence Address: NOTARO & MICHALOS P.C., Suite 110, 100 Dutch Hill Road, Orangeburg, NY, 10962-2100, US

(21) Appl. No.: 10/445,486

(22) Filed: May 22, 2003

(30) Foreign Application Priority Data
May 31, 2002 (CH) 2002 0904/02

(51) Int. Cl. G01N 1/10; B01L 3/00

(52) U.S. Cl. 422/100; 422/102; 436/178; 436/180

(57) ABSTRACT

A device (1) and/or a corresponding system and method are disclosed for aspirating liquids (2) from wells (3) and/or extraction chambers (4) of SPE plates (5) for solid phase extraction and elution of organic and/or inorganic particles—these extraction chambers (4) each having an outlet (8), positioned on the bottom side (6) of the wells (3) and including an annular wall (7), which has an outlet opening (9). Such devices (1) include at least one suction chamber (11) delimited by enclosure means (10); at least one receiving opening (12), positioned in a part of the enclosure means (10), having an edge region (13), which may be sealed to the surrounding atmosphere (14) by applying at least a part of such an SPE plate (5); and at least one partial vacuum line (15), which leads to the suction chamber (11) and may be connected to a suction pump, for evacuating the suction chamber (11), and a suction element (18) having multiple suction openings (19), the number and distribution of the suction openings (19) corresponding to the number and distribution of the outlet openings (9) of the wells (3) and/or extraction chambers (4) of an SPE plate (5) placed on the edge regions (13), and the annular wall (7) of each of these outlets (8) able to be positioned in relation to a suction opening (19) in such a way that it forms an annular gap (20) together with this suction opening (19). A device (1) according to the present invention and/or a method according to the present invention is distinguished in that the device (1) includes an intermediate space (21), which is defined by the suction element (18), the bottom side of the SPE plate (5), and the enclosure means (10), the suction element (18) being positioned on the enclosure means (10) to form a seal, and the enclosure means (10) including a ventilation valve (22), via which a flushing gas may be introduced and/or is introduced into this intermediate space (21).

### RELATED PATENT APPLICATIONS

This patent application claims priority of the Swiss patent application No. CH 0904/02 filed on May 31, 2002.

### FIELD OF THE INVENTION

The present invention relates to a device according to the preamble of independent claim 1, a corresponding system according to the preamble of claim 10, and a method according to the preamble of independent claim 13 for aspirating liquids from wells and/or extraction chambers of SPE plates for solid phase extraction and elution of organic and/or inorganic particles.

In laboratories which are concerned with molecular biological/biochemical assays, the fields of “genomics” or “proteomics” are common terms for the processing and assay of genetic substances, including DNA (deoxyribonucleic acid), RNA (ribonucleic acid), and/or their parts in the form of oligonucleotides or proteins (e.g., in the form of antigens or antibodies and/or their parts in the form of poly-peptides). These and similar processes may include multiple work steps in different workstations. The field of proteomics in particular is increasingly gaining in significance, because not only the genome (genetic mass) but rather above all the particular protein configuration present (proteome) determines the appearance and state of a biological organism. This recognition has led to a deeper understanding of the proteins as the actual regulation network taking the place of the dogma of “one gene—one protein—one function”. Proteomics—the quantitative analysis of the proteins present in an organism at a specific point in time and under specific conditions—is therefore being profiled as an important key for functional analysis both in basic research (e.g., for the explanation of reaction and regulation networks) and for applied research (e.g., for searching out and selecting targets for developing medications).

### RELATED PRIOR ART

Systems which are capable of performing automated separation or purification methods typically use “SPE plates” (solid phase extraction plates) for processing samples, particularly for solid phase extraction and elution of organic and/or inorganic particles. In this case—depending on the goal of the application—a specific activated filter, a corresponding lattice, or even a separating column in the form of a packed capillary is placed in or at least near the floor outlet opening of a well of a microplate (cf. FIG. 1: SPE plates from the related art). To perform a separation method, a sample is pipetted into a well and, through the application of suction forces (by applying vacuum) or gravity (by centrifuging), is forced to leave the microplate through the filter and/or the lattice via the floor outlet opening.

The principal of solid phase extraction may be summarized as follows: a sample is applied to a solid sorbent. The sorbent adsorbs or binds specific components of the sample. These components are often called target molecules, however, such components may be not only non-ionic components, but also ionic or even particular components such as cells, cell fragments, such as mitochondria or cell nuclei, or even viruses. In the following, all of the components and target molecules cited above are included under the term “particles”. After the adsorption step, the remaining sample components are separated from the sorbent charged with target molecules through solid phase extraction. Subsequently, the sorbent is typically washed. Finally, the target molecules (i.e., the particles) are eluted from the solid sorbent. The eluate contains a purified or concentrated fraction of the target molecules (i.e., the particles).

In the course of this method, the target molecules therefore binds to the activated material, e.g., the separating column or packing. After the performance of several washing steps and the particular drainage of the wash waste material using vacuum or centrifugation, the target molecules and/or the organic and/or inorganic particles separated from the sample in this way may be eluted with the aid of an eluent (a suitable solvent), i.e., separated from the packing, from the filter, and/or from the lattice. Subsequently, the eluted particles are transferred into a second microplate or onto the surface of a carrier using vacuum or centrifugation.

### PROBLEMS RELATED TO THE PRIOR ART

The aspirating of the liquids from the SPE plates is more suitable for automation of these separation or purification methods than a corresponding centrifugation. However, the implementation of this statement in practice requires overcoming multiple technical obstacles: the emptying of all wells is typically achieved through sudden, abrupt application of a high partial vacuum, which is performed by abruptly opening a valve leading to a pre-evacuated vacuum tank. Typically, SPE plates include a projecting outlet on their bottom side for each well (cf. FIG. 1A). Such a sudden application of a vacuum, however, often leads to spraying or even foaming wash waste material, so that contamination (sample transfer from one outlet of an SPE plate to a neighboring outlet) is a concern. Sources for contamination or even for cross contamination may also be droplets hanging on these outlets (cf. FIG. 1B), which could also fill a possibly existing dead volume (cf. FIG. 1A), which are shaken off from the SPE plates through shakings and/or vibrations caused by manual or automatic manipulation of the SPE plates using a robot.

To avoid the transfer of samples to another outlet or into another well of the collecting plate, a collecting plate is therefore used which has an identical well distribution as the SPE plate, so that precisely one outlet of the SPE plate is positioned in each well of such a collecting plate. In the related art, such collecting plates are known, which do have effective devices against spraying of the wash waste material, but may themselves give rise to contamination through droplets hanging on the outlets.

A sample processing system having a suction element for automatic extraction of compounds from microtitration plates is known from U.S. Pat. No. 6,133,045. The suction element used there is always used for aspirating liquids from a multiwell plate and for feeding these liquids into a waste container.

### SUMMARY OF THE INVENTION

The object of the present invention is to suggest an alternative device and/or an alternative method for aspirating liquids from SPE plates for solid phase extraction and elution of organic and/or inorganic particles, which allows the disadvantages of the devices and methods described as the related art to be essentially eliminated.

This object is achieved in regard to a first aspect with a device according to the features of independent claim 1. This object is achieved in regard to a second aspect with a method according to the features of independent claim 13. Additional features according to the present invention result from the dependent claims.

The advantages of the device according to the present invention over the related art include the following:

The device includes a special ventilation valve, preferably able to be mechanically triggered by a robot arm and/or a gripper situated thereon, which may be opened very rapidly and/or suddenly following the washing of the samples, through which—thanks to a preferably provided vacuum tank of the device, for example—a strong gas flow arises through the annular gap between the shielding tube and the outlets of the wells of the SPE plate, which are situated practically concentrically therein. This gas and/or airflow carries along all droplets of the wash waste material which are still possibly hanging on the outlets.

### BRIEF DESCRIPTION OF THE DRAWINGS

The following schematic figures are to document the known related art. Preferred embodiments of the device according to the present invention are also explained on the basis of such figures, without this restricting the scope of the present invention.

FIG. 1A shows a vertical partial section through a first device for emptying an SPE plate from the related art;

FIG. 1B shows a vertical partial section through a second device for emptying an SPE plate from the related art;

FIG. 2 shows a vertical partial section through a device according to the present invention according to a first embodiment;

FIG. 3 shows an enlarged vertical partial section through a device according to the present invention according to the first embodiment, corresponding to the circle in FIG. 2.

### DETAILED DESCRIPTION OF PRIOR ART

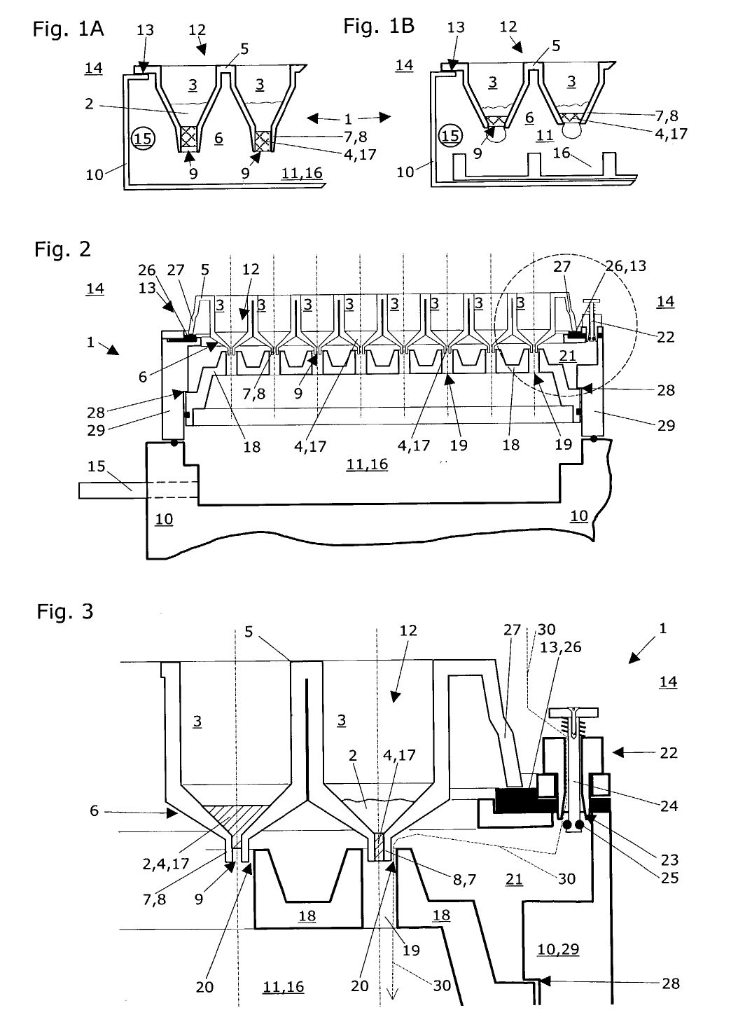

FIG. 1 shows vertical partial sections through devices for emptying an SPE plate from the related art. These devices 1 are conceived for aspirating liquids 2 from wells 3 of SPE plates 5. These SPE plates 5 are implemented for solid phase extraction and elution of organic and/or inorganic particles. These devices from the related art include a suction chamber 11, delimited by enclosure means, 10, and a receiving opening 12, positioned in a part of the enclosure means 10, having an edge region 13. This edge region 13 may be sealed to the surrounding atmosphere 14 by having at least a part of this SPE plate 5 applied to it. In the context of the present invention, gases, such as nitrogen and other inert gases, as well as air and other gas mixtures, but also liquids or liquid-gas mixtures which could not penetrate into the section chamber 11 via the path provided, i.e., via the lower outlets 8 of the SPE plates 5, are considered as the surrounding atmosphere 14. For evacuation of the suction chamber 11, a vacuum line and/or partial vacuum line 15 is provided, which leads to the chamber and is connectable to a suction pump (not shown). The suction chamber 11 (cf. FIG. 1A) and/or a shell subdivided using intermediate walls, in whose shell parts the liquids 2 exiting from the outlet openings 9 of the SPE plate 5 are to be collected (cf. FIG. 1B), is used as the collecting chamber 16. Separating means 17 (or sorbents; e.g. filter) are used in the extraction chambers 4. As described above, the emptying of all wells through sudden, abrupt application of a high partial vacuum may lead to spraying or even foaming wash waste material or eluate and therefore to undesired material transfers into neighboring wells and/or to the loss of one sample, multiple samples, or all samples of a batch.

### DETAILED DESCRIPTION OF THE INVENTION

FIG. 2 shows a device 1 for aspirating liquids 2 from wells 3 and/or extraction chambers 4 of SPE plates 5 for solid phase extraction and elution of organic and/or inorganic particles. These extraction chambers 4 each have an outlet 8, positioned on the bottom side 6 of the well 3 and including an annular wall 7, having an outlet opening 9. This annular wall 7 may be provided on the bottom side 6 of the well 5 as a cannula, as a conical floor, or even as a flat floor and may have a round design or a design deviating from the round shape (e.g., a square base). This outlet may project more or less under the bottom side 6 of the SPE plate 5 and/or the well 3 or even be implemented as a cone (cf. FIG. 1B). The device 1 includes at least one suction chamber 11 delimited by enclosure means 10 and at least one receiving opening 12, positioned in a part of the enclosure means 10, having an edge region 13, which may be sealed to the surrounding atmosphere 14 by having at least a part of such an SPE plate 5 applied to it. Preferably, the edge region 13 includes an elastic flat seal 26, which may have the outer edge 27 of an SPE plate 5 applied to it to form a seal. The device also includes at least one partial vacuum line 15, leading to the suction chamber 11 and connectable to a suction pump, for evacuating the suction chamber 11. The device 1 according to the present invention also includes a suction element 18 having multiple suction openings 19, the number and distribution of these suction openings 19 corresponding to the number and distribution of the outlet openings 9 of the wells 3 and/or extraction chambers 4 of an SPE plate 5 placed on the edge region 13. In this case, the annular wall 7 of each of these outlets 8 may be positioned in relation to a suction opening 19 in such a way that it forms an annular gap 20 together with this suction opening 19. Preferably, suction element 18 and SPE plate 5 may be positioned in relation to one another using this device 1 in such a way that the annular walls 7 of the SPE plate 5 dip by a predetermined amount into the suction openings 19 of the suction element 18. The vacuum applied to the suction chamber 11 causes the wash liquids 2 and/or wash waste materials to be suctioned out of the wells 3 and the extraction chambers 4 and to reach the suction chamber 11 directly via the suction openings 19 individually by well, without the transfer of liquids or sample parts from one outlet let 8 to another outlet having to be a concern. The annular gap 20 between the annular wall 7 and the suction opening 19 may be permanently open (cf. FIGS. 2 and 3), through which the intermediate space 21 and the suction chamber 11 may be permanently connected to one another. Alternatively, this annular gap 20 may also be closed (not shown), through which the intermediate space 21 is separated completely from the suction chamber 11, at least during the aspirating of the wash liquids. The suction element 18 is preferably tailored to the particular SPE plates 5 used in such a way that an essentially uniform annular gap 20 arises, even if the outlets 8 of the SPE plate 5 are not to be round.

For defining a specific position of the annular walls 7 of these outlets 8 of the SPE plates 5 in relation to the suction openings 19 of the suction element 18, the suction element 18 and the enclosure means 10 are preferably fixable in relation to one another in the Z direction, i.e., perpendicular to the horizontal, so that the SPE plates always assume exactly the same position for their automatic processing. This fixing may be produced through a stop 28 between suction element 18 and enclosure means 10 (cf. FIG. 2). Alternatively, the suction element 18 and at least a part 29 (shown vertically here) of the enclosure means 10 may be implemented in one piece (not shown). In both cases, the device 1 includes an intermediate space 21, which is defined by the suction element 18, the bottom side 6 of the SPE plate 5, and the enclosure means 10. The flooding and/or ventilation of this intermediate space 21 using a flushing or separation gas is necessary in order to be able to lift the SPE plate 5 from the device 1. This lifting, but preferably also insertion of the SPE plate 5 into the device 1, is preferably performed using a robot arm (not shown), which is preferably equipped with two grippers for grasping the SPE plates on both sides.

For flooding the intermediate space 21 with a gas, the enclosure means 10 includes a ventilation valve 22, via which this flushing gas (e.g., N₂, CO₂, Ar, or air) may be introduced into the intermediate space 21. This ventilation valve 22 is preferably actuated by the arm of a robot for transporting an SPE plate 5 and/or by one of its grippers. In this case, it is especially preferable to implement and guide the gripper in such a way that, as the robot arm is lowered, the gripper opens the ventilation valve immediately before gripping the SPE plate. The ventilation valve 22 includes, for example, as shown in FIG. 3, a valve seat 23 and a spring-loaded valve body 24 having a seal 25. For opening of the valve 22 by a robot for transporting an SPE plate 5, this seal 25 may be lifted with the valve body 24 essentially vertically from the valve seat 23. Alternate valves, such as those having a rocker mechanism or other variants, in which the valve body 24 of the ventilation valve 22 is implemented so it may be pressed down by an arm of the robot for transporting an SPE plate 5 and/or its gripper and which may be triggered by the robot arm, are suggested to one skilled in the art in the knowledge of the present invention without anything further and thus are included in the scope of the present invention.

A system for automatic processing of samples, which also includes a vacuum pump and thus all necessary supply lines and/or distributors and valves, preferably includes one or more of the devices 1 just described. Such systems preferably also include at least one robot arm and controllers and drives for operating this robot arm and its gripper. In addition, such a system preferably also includes at least one pipetting and/or dispensing machine for pouring the liquids 2 into the wells of the SPE plates 5. A computer having appropriately tailored software, which also includes a screen for displaying the operating status and/or parameters of individual method steps or entire protocols, is suitable for monitoring the process and the robot movements.

A device 1 according to claim 1 is used for performing the method according to the present invention for aspirating liquids 2 from wells 3 and/or extraction chambers 4 of SPE plates 5 for solid phase extraction and elution of organic and/or inorganic particles, this device 1 including an intermediate space 21, which is defined by the suction element 18, the bottom side of the SPE plate 5, and the enclosure means 10, and the suction element 18 being positioned on the enclosure means 10 to form a seal. The method is distinguished by the method step in which, after the aspiration of liquids 2 from the wells 3 and/or extraction chambers 4 of SPE plates 5, a flushing gas is introduced via a ventilation valve 22, which the enclosure means 10 includes, into this intermediate space 21.

This method is preferably performed in an automated system. In this case, there are two basic alternatives to differentiate between: According to a first variant, the suction element 18 and the SPE plate 5 are positioned in relation to one another using this device 1 in such a way that the annular walls 7 of the SPE plate 5 dip by a predetermined amount into the suction openings 19 of the suction element 18, so that the annular gaps 20 are open. Therefore, the ventilation valve 22 may be opened after the washing, a flushing gas introduced into the intermediate chamber 21, and—corresponding to the dashed arrow 30 in FIG. 3—a larger gas flow thus generated in the permanently open annular gaps 20. This gas flow, which is accelerated further by the narrowness of the annular gaps 20, is used for the purpose of picking up droplets possibly hanging on the outlets 8 and pulling them off through the suction openings 19.

According to a second variant, the suction element 18 and the SPE plate 5 are positioned in relation to one another using this device 1 in such a way that the annular walls 7 of the SPE plate 5 dip by a predetermined amount into the suction openings 19 of the suction element 18, so that the annular gaps 20 are closed. Therefore, the ventilation valve 22 may be opened after the washing and a flushing gas may be introduced into the intermediate space 21 until atmospheric pressure conditions exist therein. Subsequently, the SPE plate 5 is lifted and in this way a greater gas flow—corresponding to the dashed arrow 30 in FIG. 3—is thus generated in the annular gaps 20, which are only now opened. This gas flow, which is accelerated further through the initial narrowness of the annular gaps 20, is also used for the purpose of picking up droplets possibly hanging on the outlets 8 and pulling them off through the suction openings 19.

In both cases, the opening of the ventilation valve 22 and/or the lifting of the SPE plate 5 is preferably performed by an arm of a robot for transporting the SPE plate 5.

The preferred attachment of a “vacuum accumulator”, i.e., a chamber (not shown), which has a volume multiple times larger than the total volume of the suction chamber 11, prevents the occurrence of pressure surges which are suddenly too high. In this way, the partial vacuum may be kept constant below the limiting value in a simple way and the use of a higher-performance and more expensive pump may be dispensed with.

The device preferably has a modular construction, so that individual parts may be replaced at any time and/or used further for another purpose and in combination with further components (not shown here). Thus, for example, an automatic system may include multiple stations which may be equipped alternately with the suction bodies described above or with other devices, such as elution plates for applying samples onto object carriers or targets for microscopy or for analysis. One skilled in the art will perform such assignments from various aspects, thus, functional reliability, production costs, and ease of service and/or replaceability of individual parts and the performance of an optimated process sequence, from the addition of the samples, over their processing to the elution of the corresponding isolates and their dispensing directly on the surface of practically any arbitrary target (e.g., for MALDI-MS, fluorometry, etc.), each play an important role. The time necessary for performing certain work steps may also have an influence on the number and distribution of the workstations.

Additional possibilities for improvement and/or combination result if the edge region 13 includes an elastic flat seal 26. To improve the sealing effect, the device 1 preferably includes additional pressing means (not shown), which press the outer edge of the SPE plate 5 onto this flat seal 26.

In addition, a cover may be provided for covering the wells 3 of the SPE plate (not shown), which may alternately be attached to a robot arm implemented as an additional pressing means and, using this, may be lowered onto the SPE plate and/or removed from this SPE plate. This cover preferably has at least one seal, which may be applied to the SPE plate as a whole or individually by well to form a seal. If SPE plates 5 having large outlet openings 9 are used, the separating means 17 used (e.g., filter or lattice) often have a different flow resistance for the washing agent and/or the eluate so that—if vacuum is used for emptying the SPE plates—some wells are emptied more rapidly than others. The flow resistance for the air flowing after in the wells just emptied is significantly lower than the flow resistance for the liquids in the wells not yet emptied; this leads to an undesired and uncontrollable pressure increase in the vacuum. The emptying of all wells is therefore typically achieved through sudden, abrupt application of a large partial vacuum, which is performed through sudden opening of a valve leading to a pre-evacuated vacuum 10. This may in turn lead to transfer of samples to the outlets 8 of the neighboring well and therefore to contamination of neighboring samples. Through application and/or pressing of such a cover to form a seal, the quantity of the air flowing after is limited and therefore a larger gas flow is generated when the ventilation valve 22 is opened, which is used for the purpose of picking up droplets possibly hanging on the outlets 8 and pulling them off through the suction openings 19.

Identical parts are provided with identical reference numbers in the figures, the corresponding titles apply in this case even if they are not expressly listed and/or noted in each case. Any arbitrary combinations of the features shown and/or described are a component of the present invention.

What is claimed is:

1. A device (1) for aspirating liquids (2) from wells (3) and/or extraction chambers (4) of SPE plates (5) for solid phase extraction and elution of organic and/or inorganic particles—these extraction chambers (4) each having an outlet (8), positioned on the bottom side (6) of the wells (3) and including an annular wall (7), which has an outlet opening (9)—including:
at least one suction chamber (11) delimited by enclosure means (10);
at least one receiving opening (12), positioned in a part of the enclosure means (10), having an edge region (13), which may be sealed to the surrounding atmosphere (14) by applying at least a part of such an SPE plate (5);
at least one partial vacuum line (15), which leads to the suction chamber (11) and may be connected to a suction pump, for evacuating the suction chamber (11),
a suction element (18) having multiple suction openings (19), the number and distribution of these suction openings (19) corresponding to the number and distribution of the outlet openings (9) of the wells (3) and/or extraction chambers (4) of an SPE plate (5) placed on the edge regions (13), and the annular wall (7) of each of these outlets (8) able to be positioned in relation to a suction opening (19) in such a way that it forms an annular gap (20) together with this suction opening (19),
characterized in that the device (1) includes an intermediate space (21), which is defined by the suction element (18), the bottom side of the SPE plate (5), and the enclosure means (10), the suction element (18) being positioned on the enclosure means (10) to form a seal, and the enclosure means (10) including a ventilation valve (22), via which a flushing gas may be introduced into this intermediate space (21).

2. The device according to claim 1,
characterized in that the suction element (18) and the SPE plate (5) may be positioned in relation to one another using this device (1) in such a way that the annular walls (7) of the SPE plate (5) dip by a predetermined amount into the suction openings (19) of the suction element (18).

3. The device according to claim 1,
characterized in that, to open it, the ventilation valve (22) may have an arm of a robot for transporting an SPE plate (5) applied to it.

4. The device according to claim 1,
characterized in that the ventilation valve (22) has a valve seat (23) and a spring-loaded valve body (24) having a seal (25), the seal (25)—for opening the valve by an arm of a robot for transporting an SPE plate (5)—able to be raised essentially vertically from the valve seat.

5. The device according to claim 4,
characterized in that the valve body (24) of the ventilation valve (22) is implemented so it may be pressed downward by an arm of the robot for transporting an SPE plate (5).

6. The device according to claim 1,
characterized in that the annular gap (20) between the annular wall (7) and the suction opening (19) is permanently open and the intermediate space (21) and the suction chamber (11) are thus continuously connected to one another.

7. The device according to claim 1,
characterized in that the edge region (13) includes an elastic flat seal (26), which may have the outer edge (27) of an SPE plate (5) applied to it to form a seal.

8. The device according to claim 1,
characterized in that—for defining a specific position of the annular walls (7) of these outlets (8) of the SPE plates (5) in relation to the suction openings (19) of the suction element (18)—the suction element (18) and the enclosure means (10) may be fixed in relation to one another in the Z direction or the suction element (18) and at least a part of the enclosure means (10) are implemented in one piece.

9. The device according to claim 1,
characterized in that it includes at least one cover, which is implemented to be applied to an SPE plate (5) placed on the edge region (13) to form a seal.

10. A system for automatic processing of samples, which includes a vacuum pump,
characterized in that the system has one or more devices according to claim 1.

11. The system according to claim 10,
characterized in that it includes at least one robot arm and controllers and drives for operating this robot arm.

12. The system according to claim 10,
characterized in that it also includes at least one pipetting and/or dispensing machine.

13. A method of aspirating liquids (2) from wells (3) and/or extraction chambers (4) of SPE plates (5) for solid phase extraction and elution of organic and/or inorganic particles—these extraction chambers (4) each having an outlet (8), positioned on the bottom side (6) of the wells (3) and including an annular wall (7), which has an outlet opening (9), and a device (1) being used, which includes at least one suction chamber (11) delimited by enclosure means (10); at least one receiving opening (12), positioned in a part of the enclosure means (10), having an edge region (13), which may be sealed to the surrounding atmosphere (14) by applying at least a part of such an SPE plate (5); and at least one partial vacuum line (15), which leads to the suction chamber (11) and may be connected to a suction pump, for evacuating the suction chamber (11); and a suction element (18) having multiple suction openings (19), the number and distribution of the suction openings (19) corresponding to the number and distribution of the outlet openings (9) of the wells (3) and/or extraction chambers (4) of an SPE plate (5) placed on the edge regions (13), and the annular wall (7) of each of these outlets (8) able to be positioned in relation to a suction opening (19) in such a way that it forms an annular gap (20) together with this suction opening (19),
characterized in that the device (1) includes an intermediate space (21), which is defined by the suction element (18), the bottom side of the SPE plate (5), and the enclosure means (10), the suction element (18) being positioned on the enclosure means (10) to form a seal, and, after the aspiration of liquids (2) from the wells (3) and/or extraction chambers (4) of SPE plates (5), a flushing gas being introduced into this intermediate space (21) via a ventilation valve (22), which the enclosure means (10) include.

14. The method according to claim 13,
characterized in that a device (1) or system is used.

15. The method according to claim 13,
characterized in that the suction element (18) and the SPE plate (5) are positioned in relation to one another using this device (1) in such a way that the annular walls (7) of the SPE plate (5) dip by a predetermined amount into the suction openings (19) of the suction element (18), so that the annular gaps (20) are open or closed.

16. The method according to claim 14,
characterized in that the suction element (18) and the SPE plate (5) are positioned in relation to one another using this device (1) in such a way that the annular walls (7) of the SPE plate (5) dip by a predetermined amount into the suction openings (19) of the suction element (18), so that the annular gaps (20) are open or closed.

17. The method according to claim 15,
characterized in that, after the washing, the ventilation valve (22) is opened, a flushing gas is introduced into the intermediate space (21), and in this way a greater gas flow is generated in the permanently open annular gaps (20).

18. The method according to claim 15,
characterized in that, after the washing, the ventilation valve (22) is opened, a flushing gas is introduced into the intermediate space (21) until atmospheric conditions exist therein, the SPE plate (5) is lifted, and in this way a greater gas flow is generated in the annular gaps (20), which are only opened now.

19. The method according to claim 17,
characterized in that the opening of the ventilation valve (22) and/or the lifting of the SPE plate (5) is performed by an arm of a robot for transporting the SPE plate (5).

20. The method according to claim 18,
characterized in that the opening of the ventilation valve (22) and/or the lifting of the SPE plate (5) is performed by an arm of a robot for transporting the SPE plate (5).
